(19) United States
(12) Patent Application Publication
(10) Pub. No.: US 2013/0162196 A1
(43) Pub. Date: Jun. 27, 2013

(54) CHARGER

(71) Applicant: Chun-Sheng LI, Jiangsu Province (CN)

(72) Inventor: Chun-Sheng LI, Jiangsu Province (CN)

(73) Assignee: DELTA ELECTRONICS (SHANGHAI) CO., LTD., Shanghai (CN)

(21) Appl. No.: 13/429,457

(22) Filed: Mar. 26, 2012

(30) Foreign Application Priority Data
Dec. 23, 2011 (CN) 201110440341.7

(51) Int. Cl. H02J 7/00

(52) U.S. Cl. 320/107

(57) ABSTRACT

The invention provides a charger for charging a storage battery. The charger includes a power switching module receiving DC electric energy and outputting a charging voltage or current provided for the storage battery; and a control processor including a charging curve control unit, a memory unit and an operation control unit. The memory unit is used for storing the charging curve, parameters and control signals of different charging stages of the storage battery. The operation control unit is used for controlling the operation of the charging curve control unit. The charging curve control unit receives a voltage and/or current detecting signal outputted from a charging detecting module and controls the charging curve and parameters of different charging stages of the storage battery provided by the power switching module to be consistent with the corresponding values stored in the memory unit.

### RELATED APPLICATIONS

This application claims priority to China Application Serial Number 201110440341.7, filed Dec. 23, 2011, which is herein incorporated by reference.

### BACKGROUND

1. Field of Invention

The invention relates to charging a storage battery. More particularly, the invention relates to a charger for charging a storage battery.

2. Description of Related Art

A storage battery is an electrochemical apparatus that provides and stores electrical energy, and is widely used in emergency power supplies, electric vehicles and the like. With the development of emergency power supplies, electric vehicles and the like, the demand for storage battery chargers is increasing year by year.

FIG. 1 illustrates a block diagram of a conventional storage battery charger. As shown in FIG. 1, the charger 10 receives power from an external AC (alternating current) power supply and charges a storage battery. The charger 10 includes a rectifier circuit 11, a power switching circuit 12, a current detecting circuit 13, a voltage detecting circuit 14 and a control circuit 15. However, if the charger 10 receives power from a DC (direct current) power supply, the rectifier circuit 11 may be omitted from the configuration of the charger 10.

The rectifier circuit 11 converts the inputted AC electrical energy into DC (direct current) electrical energy. The current detecting circuit 13 and the voltage detecting circuit 14 are used for detecting current and voltage, respectively, and transmitting current and voltage detecting signals to the control circuit 15. The control circuit 15 receives the current and voltage detecting signals transmitted from the current detecting circuit 13 and the voltage detecting circuit 14, compares the current and voltage detecting signals with default values to obtain differences there between, and subsequently adjusts the output of the power switching circuit 12 in a manner corresponding to the obtained differences. The output of the power switching circuit 12 adjusted in this manner is used to charge the storage battery.

In brief, in a conventional charger, the electrical energy outputted to the storage battery is controlled by controlling the outputted current or voltage of the power switching circuit 12. Furthermore, in the conventional technology, the charging process is often divided into multiple stages, in each of which a single physical quantity is controlled.

FIG. 2 illustrates a typical charging process of a conventional storage battery. As shown in FIG. 2, the charging process is divided into three stages. Particularly, in a first stage (T₀₀-T₀₁), when the terminal voltage of the storage battery is very low, a large constant current I₀₁ is used for charging the storage battery until the terminal voltage increases to a predetermined voltage value, after which the charging process changes into a second stage (T₀₁-T₀₂). In the second stage, a constant voltage V₀₁ is used for charging the storage battery until the charging current decreases to a predetermined current value, after which the charging process changes into a third stage (T₀₂-T₀₃). In the third stage, another constant voltage V₀₂ is used for charging until time T₀₃, where V₀₂<V₀₁.

However, a conventional charger is designed for a storage battery having a specific charging process. The conventional charger often has two characteristics which cause poor versatility of the conventional charger. First, the charging process of the conventional charger can not be changed, such that the conventional charger is only applicable to a special type of storage battery (for example, a charger designed for a nickel-hydrogen battery cannot be used to charge a lead-acid battery). Second, in the charging process of the conventional charger, the outputted voltage of each stage is fixed, such that the conventional charger is not applicable to a changed number of storage batteries (for example, a charger designed for 12 storage batteries can not fully charge 13 storage batteries). Additionally, even storage batteries of the same type and number, the requirement for an optimum charging process varies depending on the manufacturer of the storage batteries.

### SUMMARY

In order to improve the poor versatility of a conventional charger, the invention provides a charger for charging a storage battery. The charger includes a power switching module receiving DC electrical energy and outputting a charging voltage or current provided for the storage battery; a charging detecting module for detecting the charging voltage and/or current of the storage battery provided by the power switching module and outputting a charging voltage and/or current detecting signal; a control processor including a charging curve control unit, a memory unit and an operation control unit. The memory unit is used for storing the charging curve, parameters and control signals of different charging stages of the storage battery. The operation control unit is used for controlling the operation of the charging curve control unit. The charging curve control unit receives a voltage and/or current detecting signal outputted from the charging detecting module and controls the charging curve and parameters of different charging stages of the storage battery provided by the power switching module to be consistent with the corresponding values stored in the memory unit.

In an embodiment of the invention, the charging parameters of different charging stages include the charging voltage and/or current of different charging stages, charging time, end parameters of different charging stages, and a charging mode.

In another embodiment of the invention, the output of the operation control unit activates/stops the charging curve control unit.

In a further embodiment of the invention, the operation control unit receives a turning on/off instruction outputted by a user end, a voltage and/or current detecting signal outputted by the charging detecting module, and a charging control signal pre-stored in the memory unit.

In still a further embodiment of the invention, the charger further includes at least one communication port, and the control processor further comprises a communication program unit corresponding to the communication port. The communication port receives and outputs the user end setting to the communication program unit. The communication program unit translates and outputs the user end setting into the memory unit and/or the operation control unit.

In still yet a further embodiment of the invention, the communication port may be connected with a corresponding communication adapter, so as to provide an operation port of the charger for the user end or the out-plant system.

In an embodiment of the invention, the communication program unit can inverse translate the parameter setting of the storage battery stored in the memory unit and subsequently outputs the parameter setting through the communication port.

In an embodiment of the invention, the user end updates the charging curve, the charging parameters and the charging control signal of different charging stages of the storage battery stored in the memory unit through the communication port.

In another embodiment of the invention, the charger has at least one digital input/output port, and the control processor further includes a digital input/output program unit corresponding to the digital input/output port. The digital input/output port receives and outputs the user end setting to the digital input/output program unit, and the digital input/output program unit controls the operation control unit according to the user end setting.

In a further embodiment of the invention, the digital input/output program unit can receive and output information of the current operation state of the operation control unit to the digital input/output port.

In still a further embodiment of the invention, the charger includes a rectifier. An input end of the rectifier is electrically connected with an external AC power supply, and an output end of the rectifier is electrically connected with an input end of the power switching module.

Thus, through use of the charger, charging system and charging control method provided by the invention, the user end can flexibly set the charging parameters according to the characteristics of the storage battery (e.g., the type of the storage battery, the storage battery capacity and the age of the storage battery), so as to realize charging control of the storage battery. Therefore, the charger provided by the invention is highly versatile compared with the conventional charger.

### BRIEF DESCRIPTION OF THE DRAWINGS

FIG. 1 illustrates a block diagram of a conventional storage battery charger;

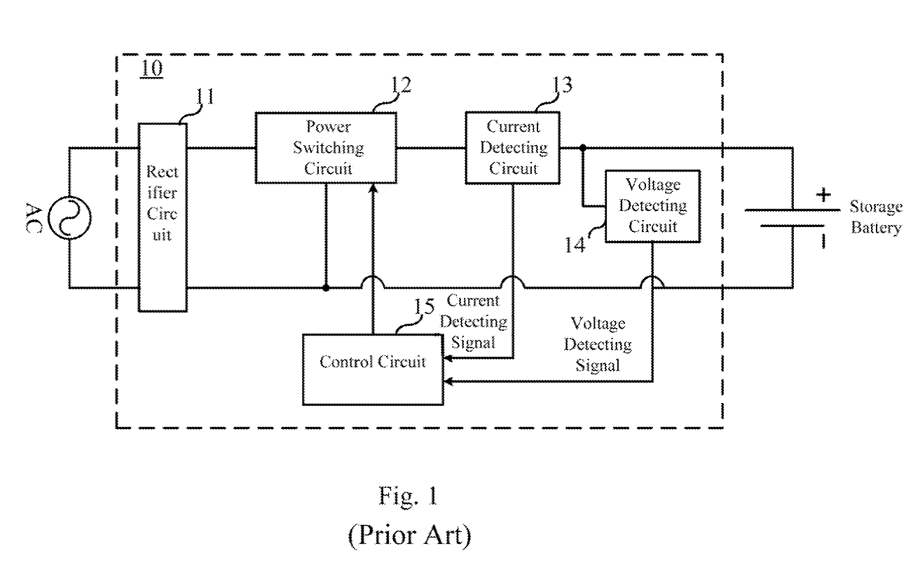

FIG. 2 illustrates a typical charging process of a conventional storage battery;

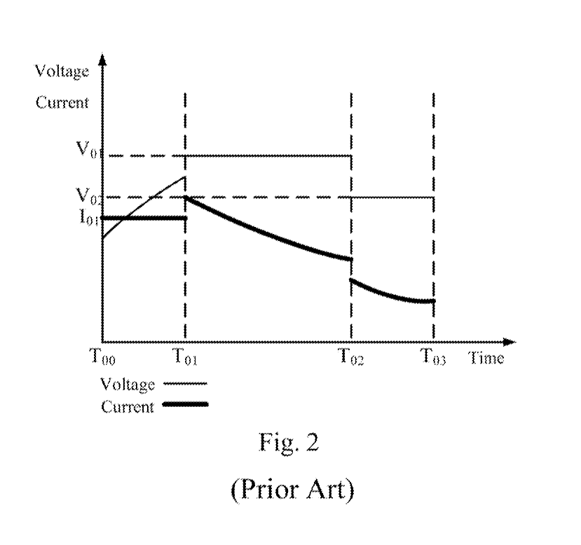

FIG. 3 illustrates a block diagram of an application system of a charger according to an embodiment of the invention;

FIG. 4 illustrates a block diagram of a preferred embodiment of the application system shown in FIG. 3; and

FIG. 5 illustrates a schematic view of a charging process of the charger shown in FIG. 4.

### DETAILED DESCRIPTION

In the following detailed description, for purposes of simplify explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

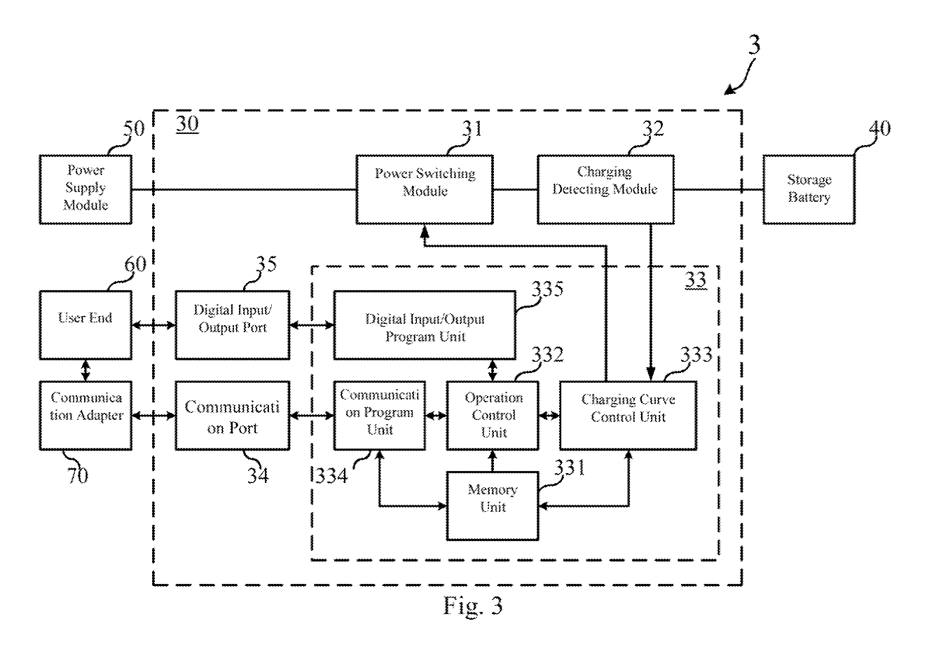

FIG. 3 illustrates a block diagram of an application system 3 of a charger 30 according to an embodiment of the invention.

As shown in FIG. 3, the charger 30 provided in an embodiment of the invention charges a storage battery 40 while receiving power from a power supply module 50. A user end 60 can set the charger 30 according to the charging curve and the charging parameters of different stages of the storage battery 40, so as to charge the storage battery 40. The charging parameters may be, but are not limited to being, charging voltage and/or current of different charging stages, charging time, end parameters of different charging stages, a charging mode and the like. It should be noted that, in this embodiment, the storage battery 40 refers to a battery which can be recovered and continually used through charging after being discharged to a certain degree, such as a lead-acid storage battery, a lithium-ion battery, a nickel-hydrogen battery or a lithium-polymer battery. In this embodiment, the user end 60 may be an out-plant system or a subscriber terminal of the charger 30. The out-plant system such as a PC or other programmable device, which can realize automatic setting of charging parameters for the charger 30 through a parameter setting program. The subscriber terminal may be, but is not limited to being, a user reality operation interface, which supports manual setting of charging parameters of the storage battery 40 for the charger 30. The charging parameters may include, but are not limited to including, the charging curve of different charging stages, the charging mode of each charging stage, the charging control quantity and a charging control target value, end conditional parameters of different charging stages, methods for processing protection matters, and other charging related information.

In this embodiment, the charger 30 includes a power switching module 31, a charging detecting module 32, a control processor 33 and a communication port 34.

In this embodiment, the power switching module 31, which is coupled between the power supply module 50 and the storage battery 40, receives DC electrical energy which can be directly provided by the power supply module 50. The power supply module 50 for example is a DC power supply. Alternatively, the power supply module 50 is an AC power supply, in which case a rectifier is included in the charger 30, with the input end of the rectifier being connected with the power supply module 50, and the output end of the rectifier being electrically connected with an input end of the power switching module 31. The output of the power switching module 31 provides a charging voltage or current to the storage battery 40.

In this embodiment, the charging detecting module 32 can be used for detecting the charging voltage and/or current of the storage battery 40 provided by the power switching module 31, and outputting a charging voltage and/or current detecting signal to the control processor 33. In other embodiments, the charging detecting module 32 can also optionally detect required parameters, such as the output power of the power switching module 31.

In this embodiment, the control processor 33 receives the detecting signal from the charging detecting module 32, and outputs a control signal for controlling the output of the power switching module 31, such that the charging values outputted by the power switching module 31 approaches a predetermined value stored in the control processor 33. As shown in FIG. 3, the control processor 33 includes a memory unit 331, an operation control unit 332 and a charging curve control unit 333. The memory unit 331 is used for storing charging related information, such as the charging curve, the charging parameters and the charging control signal of different charging stages. The operation control unit 332 is used for controlling the operation of the charging curve control unit 333. Particularly, the operation control unit 332 can start or stop the operation of the charging curve control unit 333 according to an activation/stopping instruction and other various instructions outputted by the user end 60, the voltage and/or current detecting signal outputted by the charging detecting module 32, and the charging control signal pre-stored in the memory unit 331. The charging curve control unit 333 receives the voltage and/or current detecting signal outputted by the charging detecting module 32, and controls the charging curve and charging parameters of different charging stages of the storage battery 40 provided by the power switching module 31 to be consistent with corresponding values stored in the memory unit 331. In this embodiment, the charging parameters of different charging stages include the charging voltage and/or current of different charging stages, the charging time, end parameters of different charging stages, and the charging mode.

In this embodiment, the control processor 33 further includes a communication program unit 334. The communication program unit 334 corresponds to the communication port 34. The communication port 34 is used for translating the charging curve and charging parameters of different charging stages provided by the user end 60 through the communication program unit 334 for eventual output into the memory unit 331. Certainly, the user can transfer the charging related information to other units or modules in the control processor 33 through the communication program unit 334 by the communication port 34, and can also transfer information stored in and/or fed back from the other units or modules in the control processor 33 to the user end 60 through the communication program unit 334 by the communication port 34. In other words, the communication port 34 realizes intercommunication between the user end 60 and the control processor 33. In a particular operation, if the user end 60 has to change the charging parameters stored in the memory unit 331 directly through the communication port 34 according to the charging parameters of the storage battery 40, a corresponding communication adapter 70 is directly connected with the communication port 34. The communication adapter 70 can be directly connected with the user reality operation interface used for manual setting of the charging parameters by the user, or can be connected with the programmable system so as to realize automatic program setting of the charging parameters. Thus, the type of the user end connected with the communication adapter 70 can be determined according to the environment in which the charger 30 is used. The user end 60 can update the charging curve, the charging parameters and the charging control signal of different charging stages of the storage battery 40 stored in the memory unit 331 through the communication port 34. The communication adapter 70 has a configuration that corresponds to the communication port 34. For example, when the communication port 34 is an RS485 port, the communication adapter 70 is correspondingly an RS485 adapter. The user end 60 can communicate with the charger 30 (or control processor 33) through the communication adapter 70 and the communication port 34.

In this embodiment, the charger 30 may further include at least one digital input/output port 35. Moreover, the control processor 33 further includes a digital input/output program unit 335 corresponding to the digital input/output port 35. The digital input/output port 35 can receive and output the setting of the user end 60 to the digital input/output program unit 335. The digital input/output program unit 335 controls the operation control unit 332 according to the setting of the user end 60. When the charger 30 is used for charging a storage battery of the same type, the user can control the activation and stopping of the operation control unit 332 directly through the digital input/output port 35, without changing the charging parameters. In this embodiment, the digital input/output program unit 335 can receive and output the information of the current operation state of the operation control unit 332 to the digital input/output port 35. In other embodiments, there are several digital input/output ports. One of the digital input/output ports for example can be regarded as a state display port of the charger 30. Information indicating normal operation of the operation control unit 332 can be displayed through the digital input/output port, and information indicating abnormal operation of the operation control unit 332 can also be displayed through the digital input/output port 35. Alternatively, the full charged state of the charging curve control unit 333 may be displayed through the operation control unit 332 and the digital input/output port 35. Different states may be displayed using different colors, or may be displayed through different digital input/output ports 35. Another digital input/output port can be regarded as a turning on and off port of the operation control unit 332. Thus, the specific number of the digital input/output ports can be set as required. However, it should be noted that it is possible for the charger 30 to have no digital input/output port 35 and to use the communication port 34 for such purposes. That is, the digital input/output port 35 is not necessary Correspondingly, it is possible for the control processor 33 to have no digital input/output program unit 335.

In this embodiment, the user end 60 can communicate with the control processor 33 through the communication port 34 in the charger 30. That is, the user end 60 and the control processor 33 can communicate information with each other, such that the user end 60 can provide corresponding charging parameters or other related information to the memory unit 331 in the control processor 33 according to the characteristics of the storage battery 40. Subsequently, the charging curve control unit 333 in the control processor 33 controls the power switching module 31 to perform charging control of the storage battery 40 according to the information mentioned above and the signal provided by the charging detecting module 32.

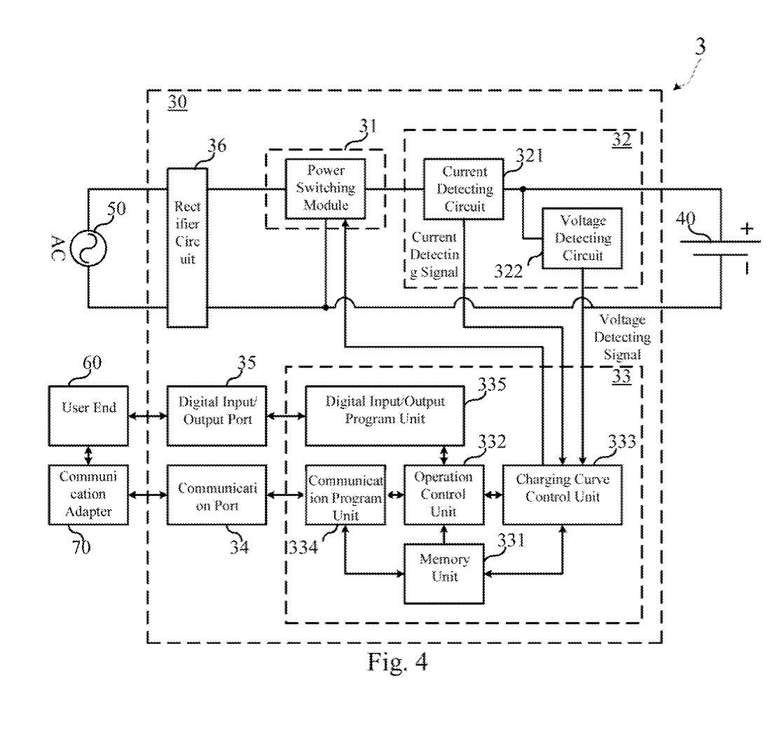

FIG. 4 illustrates a block diagram of a preferred embodiment of the application system 3 shown in FIG. 3.

As shown in FIG. 4, in this embodiment, the power supply module 50 is an AC power supply. Correspondingly, the charger 30 has a rectifier circuit 36 used for converting AC electrical energy provided by the AC power supply into DC electrical energy. The DC electrical energy can be directly transferred to the power switching module 31. The charger 30 further has a communication port 34. Optionally, the digital input/output port 35 is introduced into the charger 30 provided by this embodiment. In this embodiment, the power switching module 31 is a power switching circuit.

In this embodiment, the charging detecting module 32 includes a current detecting circuit 321 and a voltage detecting circuit 322. The current detecting circuit 321 is used for detecting the charging current of the storage battery 40 to produce a charging current detecting signal. The voltage detecting circuit 322 is used for detecting the terminal voltage of the storage battery 40 to produce a charging voltage detecting signal.

As shown in FIG. 4, the control processor 33 includes the memory unit 331, the operation control unit 332, the charging curve control unit 333, the communication program unit 334 and the digital input/output program unit 335.

The memory unit 331 is used for storing charging information translated by the communication program unit 334, such as the related charging curve, the charging parameters and the charging control signal of different charging stages of the storage battery 40. It should be noted that, in this embodiment, the memory unit 331 is disposed in the control processor 33. In some other embodiments, the memory unit 331 may be disposed external to the control processor 33 and only electrically connected with the control processor 33.

The operation control unit 332, which is coupled to the memory unit 331, reads the instruction form or source received by the operation control unit 332 and stored in the memory unit 331, and activates or stops the charging curve control unit 333. The memory unit 331 for example can pre-store whether the operation control unit 332 operates automatically or is in a form set by the user, or whether the instruction is resourced from the communication program unit 334 or the digital input/output program unit 335. In other embodiments, the operation control unit 332 is also used for receiving definitions of each digital input/output port 35 and the parameter setting of abnormal/emergency conditions of the charger from the memory unit 331. That is, the operation control unit 332 can receive abnormal condition information or protecting information of the charger 30 sent by other components in the charger 30, and compares this information with the abnormal condition information or protecting information stored in the memory unit 331 to make a corresponding determination. For example, the operation control unit 332 receives detecting signals from the current detecting circuit 321 and/or the voltage detecting circuit 322, and when the detecting signal of the current and/or voltage detecting circuit is abnormal, such as larger than a safe charging voltage or current value, the operation control unit 332 stops operation of the charging curve control unit 333. Alternatively, the charger 30 is provided with a temperature monitoring component (not shown in FIG. 4), and when the temperature of the total charger 30 is too high, such as over a normal operation temperature range for a charger stored in the memory unit 331, the operation control unit 332 also stops the charging curve control unit 333.

The charging curve control unit 333 receives the detecting signals of the current detecting circuit 321 and the voltage detecting circuit 322, reads the charging parameters of the storage battery 40 stored in the memory unit 331, receives activating and stopping instructions from the operation control unit 332, and adjusts the output of the power switching module 31 to be consistent with the charging parameters of different charging stages stored in the memory unit 331. In the mean time, the charging curve control unit 333 also can determine whether the current charging stage meets the ending requirements of the current charging stage stored in the memory unit 331. For example, when the voltage or current between two ends of the storage battery 40 has met the ending requirements of the current charging stage, the charging curve control unit 333 controls the power switching module 31 to enter the next charging stage.

In the schematic view of the charger shown in FIG. 4, the charger 30 includes a communication port 34. The control processor 33 is correspondingly provided with a communication program unit 334. With the communication program unit 334, it is possible for the user end 60 to send instructions to the operation control unit 332 in the control processor 33 through the communication port 34 and/or update the charging information of the storage battery stored in the memory unit 331 of the control processor 33. Moreover, the user reads the charging information stored in the memory unit 331 of the control processor 33, and operation state information and abnormal charging conditions of the charger fed back by the operation control unit 332. In other words, the communication program unit 334 can translate instructions of the user end 60 for other units of the control processor 33, and also can inverse translate and output the information in other units of the control processor 33. The communication port 34 shown in FIG. 3 can communicate with the user end 60 only after being connected with a corresponding communication adapter 70. In other embodiments, the communication adapter 70 may be integrated with the ports, such that the structure of the total charger 30 is more compact. Specific types of the communication port 34 and the corresponding communication adapter 70 have been described in the embodiments disclosed above, and thus a description thereof is not provided herein.

In this embodiment, the charger 30 also has a digital input/output port 35 used for transferring data between the user end 60 and the control processor 33, for example transferring some simple charging instruct information (e.g., a switch signal) provided by the user end 60 to the control processor 33 and transferring charging feedback information provided by the control processor 33 to the user end 60. Particularly, the digital input/output port 35 is used for transferring some simple information between the user end 60 and the control processor 33 when the communication port 34 is not used. Consistent with the embodiment of the charger shown in FIG. 3, the digital input/output port 35 is also an auxiliary port. The user can directly perform simple functions of the digital input/output port 35 depending on the specific functions realized by the digital input/output port 35. For example, when the digital input/output port 35 is a switch of the charger, the user can control the switch and directly control of the charger on or off. Different digital input/output ports have different functions. An operator can realize simple manual operation of the charger directly through these digital input/output ports set by the charger 30, without using the communication adapter 70. Corresponding to the digital input/output port 35, the control processor 33 is provided with a digital input/output program unit 335, so as to realize simple communication between the digital input/output port 35 and other modules or units in the control processor 33. The digital input/output program unit 335 can read and output the state information of the operation control unit to the digital input/output port 35. Specific state information has been illustrated in the embodiments described above, and thus a description thereof is not provided herein.

As shown in FIG. 4, the communication port 34 of the charger 30 can realize all the functions realized by the digital input/output port 35. If the user 60 of the charger 30 is another control system, the digital input/output port 35 may be totally omitted from the configuration of the charger 30. If the charger 30 is independently used and needs manual setting, and the current operation state of the charger 30 must be determined using the senses, use of the digital input/output port 35 is more convenient, fast and realized through visual observation. However, the reset of the charging parameters for the charger 30, i.e., the updates of the charging parameters stored in the memory unit 331 of the control processor 33 can be only realized through the communication port 34. Thus the specific structure of the charger 30 can be set depending on requirements of the user. It can be known from the embodiments of the charger 30 described above, regardless of the type of the storage battery 40, such as a lead-acid storage battery, a lithium-ion storage battery or another type of storage battery, the storage battery 40 can be charged by the same charger 30, and it is necessary only that the charging parameters for the charger 30 are set by the user end 60. Furthermore, for the storage battery 40 of the same type, if the capacity of the storage battery 40 is changed, for example, an application in which 40 storage batteries are connected in series and one faulty storage battery is removed, the user end 60 can similarly change the charging parameters. For example, the 39 storage batteries connected in series may be charged by changing the charging voltage parameters for the charger 30. The above is illustrated only as an example, and in practice the user end 60 can perform charging control of the storage battery 40 by flexibly, setting the charging parameters corresponding to the characteristics of the storage battery 40. Additionally, since in this embodiment, the communication port 34 can be used to realize communication between the user end 60 and the charger 30, the user end 60 can control charging of the storage battery 40 through the charger 30 while in close proximity to the charger 30 or while at a distance from the charger 30. For example, the user can control the charger 30 through a computer using a wired connection manner, or through a mobile terminal using a wireless connection.

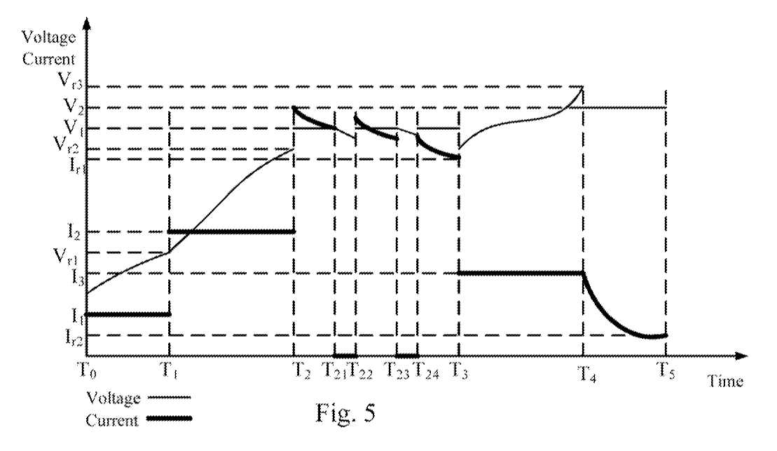

FIG. 5 illustrates a schematic view of an exemplary charging process of the charger 30 shown in FIG. 4.

As shown in FIG. 5, in this embodiment, a five-stage charging process is used for charging the storage battery 40.

First, in a first charging stage (T₀-T₁), the storage battery 40 is charged at a first constant current from time point T₀, and when the charging voltage of the storage battery 40, i.e., the voltage between two ends of the storage battery 40 detected by the charging curve control unit 333, is higher than a first predetermined voltage Vᵣ₁ stored in the memory unit 331, at time point T₁, the charging curve control unit 333 then controls the power switching module 31 to charge the storage battery 40 in a second charging stage. Generally, the memory unit 331 stores abnormal signals of different stages: For example, when the charging time of the first stage is larger than a threshold of the stage charging time stored in the memory unit 331, the charging curve control unit 333 automatically enters a charging process of the next charging stage. In other embodiments, due to the difference among the module designs or application environments, the manner of processing abnormal charging conditions of different charging stages is also different, such as stopping the current charging process and regarding the condition as a fault.

Subsequently, in a second charging stage (T₁-T₂), the charging curve control unit 333 reads the charging parameters of the second charging stage stored in the memory unit 331 from the time point T₁, and charges the storage battery 40 at a second constant current I₂. When the rising terminal voltage of the storage battery 40 is higher than a second predetermined voltage Vᵣ₂, the third charging stage starts at the time point T₂. The processing of abnormal conditions of the second charging stage is the same with the first charging stage, and thus a description thereof is not provided herein.

Thereafter, in a third charging stage (T₂-T₃), the charging curve control unit 333 reads the charging parameters of the third charging stage stored in the memory unit 331, and intermittently charges the storage battery 40 at a first constant voltage V₁. This stage is divided into three sections, the first section (T₂-T₂₁), the second section (T₂₂-T₂₃) and the third section (T₂₄-T₃), with set time intervals between each section. It should be noted that the stage is not necessarily divided into the three sections, and the number of the sections may be also less or more than three, depending on a target value of the charging current of the storage battery 40. In particular, in a certain time period, such as the first section (T₂-T₂₁), the storage battery 40 is charged at a constant voltage V₁. Then in a certain time interval, such as the time period (T₂₁-T₂₂), providing of the constant voltage V₁ is stopped temporarily. In the second section (T₂₂-T₂₃), the constant voltage V₁ is provided again to charge the storage battery 40. The steps mentioned above are repeated until the charging curve control unit 333 determines that the dropping charging current of the storage battery 40 detected by the current detecting circuit 322 is lower than a first determined current Iᵣ₁. Subsequently the fourth charging stage starts.

In a fourth charging stage (T₃-T₄), the storage battery 40 is charged at a third constant current I₃ from the time point T₃. When the rising terminal voltage of the storage battery 40 is higher than a third predetermined voltage Vᵣ₃, the fifth charging stage starts at the time point T₄.

Subsequently, in the fifth charging stage (T₄-T₅), the storage battery 40 is charged at a second constant voltage V₂ from the time point T₄. When the dropping charging current of the storage battery 40 is lower than a second predetermined current Iᵣ₂, the charging is stopped at the time point T₅.

It should be understood that charging utilizing five stages described above is only taken as an example for charging the storage battery 40, and the invention is not limited in this regard. Other methods of charging using a different number of stages and parameters within each stage may also be employed. For example, a single stage, two to four stages, six stages and seven stages may be set through the user end 60, and the charging time of different charging stages, the control quantity (the charging voltage/current), the end parameters and the like can all be flexibly set through the user end 60.

Thus, with the use of the charger provided by the invention, the user end can flexibly set the charging parameters according to the characteristics of the storage battery (e.g., the type of the storage battery, the storage battery capacity and the age of the storage battery), so as to realize charging control of the storage battery. Therefore, the charger provided by the invention has an excellent versatility compared with the conventional charger.

In the foregoing, the specific embodiments of the invention are described with reference to the accompanying drawings. However, those of ordinary skills in the art should understand that various modifications and variations can also be made to the specific embodiments of the invention without departing from the spirit and scope of the invention. These modifications and variations all fall in the scope defined by the claims of the invention.

What is claimed is:

1. A charger for charging a storage battery, comprising:
a power switching module receiving a DC electrical energy and outputting a charging voltage or current provided for the storage battery;
a charging detecting module for detecting the charging voltage and/or current of the storage battery provided by the power switching module and outputting a charging voltage and/or current detecting signal;
a control processor, comprising:
a memory unit for storing a charging curve, charging parameters and charging control signals of different charging stages of the storage battery;
a charging curve control unit receiving the voltage and/or current detecting signal outputted by the charging detecting module and controlling the charging curve and charging parameters of different charging stages of the storage battery provided by the power switching module to be consistent with the corresponding values stored in the memory unit;
an operation control unit for controlling the operation of the charging curve control unit.

2. The charger of claim 1, wherein the charging parameters of different charging stages comprises the charging voltage and/or current of different charging stages, charging time, end parameters of different charging stages, and a charging mode.

3. The charger of claim 1, wherein the output of the operation control unit activates/stops the charging curve control unit.

4. The charger of claim 1, wherein the operation control unit receives an activating/stopping instruction outputted by a user end, a voltage and/or current detecting signal outputted by the charging detecting module, and a charging control signal pre-stored in the memory unit.

5. The charger of claim 1, wherein the charger further comprises at least one communication port, and the control processor further comprises a communication program unit corresponding to the communication port, wherein the communication port receives and outputs a user end setting to the communication program unit, the communication program unit translates and outputs the user end setting into the memory unit and/or the operation control unit.

6. The charger of claim 5, wherein the communication port is connected with a corresponding communication adapter, so as to provide an operation port of the charger for the user end or an out-plant system.

7. The charger of claim 5, wherein the communication program unit inverse translates the parameter setting of the storage battery stored in the memory unit and subsequently outputs the parameter setting through the communication port.

8. The charger of claim 5, wherein the user end updates the charging curve, the charging parameters and the charging control signal of different charging stages of the storage battery stored in the memory unit through the communication port.

9. The charger of claim 1, wherein the charger has at least one digital input/output port, and the control processor further comprises a digital input/output program unit corresponding to the digital input/output port, wherein the digital input/output port receives and outputs the user end setting to the digital input/output program unit, and the digital input/output program unit controls the operation control unit according to the user end setting.

10. The charger of claim 9, wherein the digital input/output program unit receives and outputs information of the current operation state of the operation control unit to the digital input/output port.

11. The charger of any of claims 1, wherein the charger further comprises a rectifier, an input end of the rectifier is electrically connected with an external power supply, and an output end of the rectifier is electrically connected with an input end of the power switching module.
